(19) United States
(12) Patent Application Publication
(10) Pub. No.: US 2005/0289300 A1
(43) Pub. Date: Dec. 29, 2005

(54) Disable write back on atomic reserved line in a small cache system

(75) Inventors: Roy Moonseuk Kim, Austin, TX (US); Yasukichi Okawa, Kawasaki (JP); Thuong Quang Truong, Austin, TX (US)

Correspondence Address: Gregory W. Carr, 670 Founders Square, 900 Jackson Street, Dallas, TX, 75202, US

(73) Assignees: International Business Machines Corporation, Armonk, NY (US); Sony Computer Entertainment Inc., Tokyo (JP)

(21) Appl. No.: 10/875,953

(22) Filed: Jun. 24, 2004

(51) Int. Cl. G06F 12/00

(52) U.S. Cl. 711/136; 711/143

(57) ABSTRACT

The present invention provides for managing an atomic facility cache write back state machine. A first write back selection is made. A reservation pointer pointing to the reserved line in the atomic facility data array is established. A next write back selection is made. An entry for the reservation point for the next write back selection is removed, whereby the valid reservation line is precluded form being selected for the write back. This prevents a modified command from being invalidated.

### TECHNICAL FIELD

The invention relates generally to the field of computer systems and, more particularly, to small cache systems in microprocessors.

### BACKGROUND

High performance processing systems require fast memory access and low memory latency, to quickly get data to process. Because system memory can be slow to provide data to a processor, caches are designed to provide a way to keep data close to the processor with quicker access time for its data. Larger caches give better system performance overall but inadvertently can induce more latency and design complexities compared to smaller caches. Generally, smaller caches are designed to provide a fast way for a processor to synchronize or communicate to other processors in system applications level, especially in networking or graphics environment.

Processors send data to memory and retrieve data from memory, through Load and Store commands, respectively. Data from a system memory fills up the cache. A desirable condition is where most or all of data to be accessed by the processor is in the cache. This could happen if an application data size is same or smaller than the cache size. In general, cache size is usually limited by design or technology and can not contain the whole application data. This can be a problem when the processor accesses the new data, not in the cache, and no cache space is available to put the new data. Hence, the cache controller needs to find an appropriate space in the cache for the new data when it arrives from memory.

An LRU (Least Recently Used) algorithm is used by a cache controller to handle this situation. The LRU algorithm determines which location to be used for the new data based on the data access history information. If LRU selects a line which is consistent with the system memory, for example, shared state, then the new data will be over written to that location. When LRU selects a line that is marked Modified, which means that data is not consistent with the system memory and unique, cache controller forces the Modified data of this location to be written back to the system memory. This action is called a write back, or a castout, and the cache location that contains the write back data is called Victim Cache Line.

A bus agent, the bus interface unit that handles the bus command for the cache, attempts to complete the write back operation as soon as it could, by sending the data to the system memory via Bus operations. Write back (“WB”) or write back is a long latency bus operation since the data is going to the main memory.

There are two different kinds of cache control schemes. These are coherent cache scheme and non-coherent. In non-coherent, each cache has a unique copy of the data, and there can be no other cache with the same data. This approach is relatively easy to implement. However, this is inefficient, because there may be times when data should be distributed throughout a multiprocessor system. Therefore, a coherency cache scheme can be used, which ensures that the most up-to date data is used, distributed, or otherwise marked as valid.

One conventional technology that enforces coherency is the Modified, Exclusive, Shared, and Invalid (MESI) system. In MESI, data in a cache in a multiprocessor system is marked as one of the above, to ensure data coherency. The marking is done by hardware, the memory flow controller.

Snooping is the process whereby slave caches watch the system bus and compare the transferred address to addresses in the cache directory in order to keep the cache coherency. Additional operations can be performed in the case that a match is found. The terms bus snooping or bus watching are equivalent.

An invalidate command which is used as part of a snoop command, is issued to tell the other caches that their data is no longer valid and should mark that line invalid. In other words, the invalid state indicates that the line in the cache is invalid in the cache, or that the line is no longer available. Therefore, this line of data within the cache is free to be overwritten by other data transfers.

In a multi-processor system, some operations like test&set, compare&swap, or fetch&increment (or decrement) needs to be processed inseparably (that is, no other store to the same address can occur in between them). These operations are so called atomic operations. In general these operations are used for lock acquisition or semaphore operations. But some implementations provide only small building blocks like LL(Load-Locked) and SC(Store-Conditional) to build such a more functional operations. And some processors introduce Reservation flag to tie up these two operations (LL and SC) atomically together (that is, LL set up Reservation for lock variable, and SC can successfully store if that Reservation remains. Any store operation to same address can reset Reservation flag.)

In general Atomic-Facility is implemented at coherency point like a snoop cache to snoop other processor's store operations, and also to improve performance by caching a lock line. When performing atomic line data requests, there are a number of different commands. The first is load and reserve instruction. Load and reserve is issued by a source processor and looks at its associated cache to determine whether the cache has the data requested. If the target cache has the data, then a “reservation” flag is set for that cache. The reservation flag means that the processor is making a reservation for that line for lock acquisition. In another words, a lock acquisition (gaining a sole ownership) of a block of data in main memory is accomplished by first making a reservation using Load and Reserve and then modifying the reserved line to indicate its ownership via Store conditional instruction. Store conditional is conditional on the reservation flag is still active. Reservation can be lost by other processors wanting the same lock acquisition by executing Store conditional instruction or other reservation kill type snoop commands on the same line. The processor then copies the reserved information from the cache into the processor for processing Load and Reserve. Basically the processor is looking for an indication in the reserved line for unlocked data pattern so that Store conditional can be executed to complete the lock.

However, if the cache does not have the information, a BUS command is generated to try to get the information. If no other cache has the information, the data is retrieved from main memory. Once the data is received, reservation flag is set.

Due to the characteristic of the atomic operation tight loop and high likelihood of using the same lock again in normal programming, a reserved line from a first lock acquisition loop is needed for the future lock acquisitions. Hence this reserved data from the Load and Reserve instruction should not be written back to main memory as a write back, since the ownership of same data is needed for the subsequent lock acquisition loop. This improves performance since the reserved line write back and reload of same data from main memory is eliminated.

Therefore, there is a need for an atomic facility that addresses at least some of the problems associated with conventional atomic reservations.

### SUMMARY OF THE INVENTION

The present invention provides for managing an atomic facility cache write back controller. A reservation pointer pointing to the reserved line in the atomic facility cache data array is established. An entry for the reservation point for the write back selection is removed whereby the valid reservation line is precluded from being selected for the write back. In one aspect, a write back selection is made by employment of a least recently used (LRU) algorithm. In a further aspect, the write back selection is made with respect to reservation pointer.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a multi-processing system;

FIG. 2 schematically depicts an atomic facility cache;

FIG. 3 schematically illustrates a Lock acquisition command example;

FIG. 4 illustrates a write back operation flow chart; and

FIG. 5 illustrates an example block diagram of an atomic facility cache.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, and the like, have been omitted inasmuch as such details are not considered necessary to obtain a complete understanding of the present invention, and are considered to be within the understanding of persons of ordinary skill in the relevant art.

In the remainder of this description, a processing unit (PU) may be a sole processor of computations in a device. In such a situation, the PU is typically referred to as an MPU (main processing unit). The processing unit may also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless otherwise indicated.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

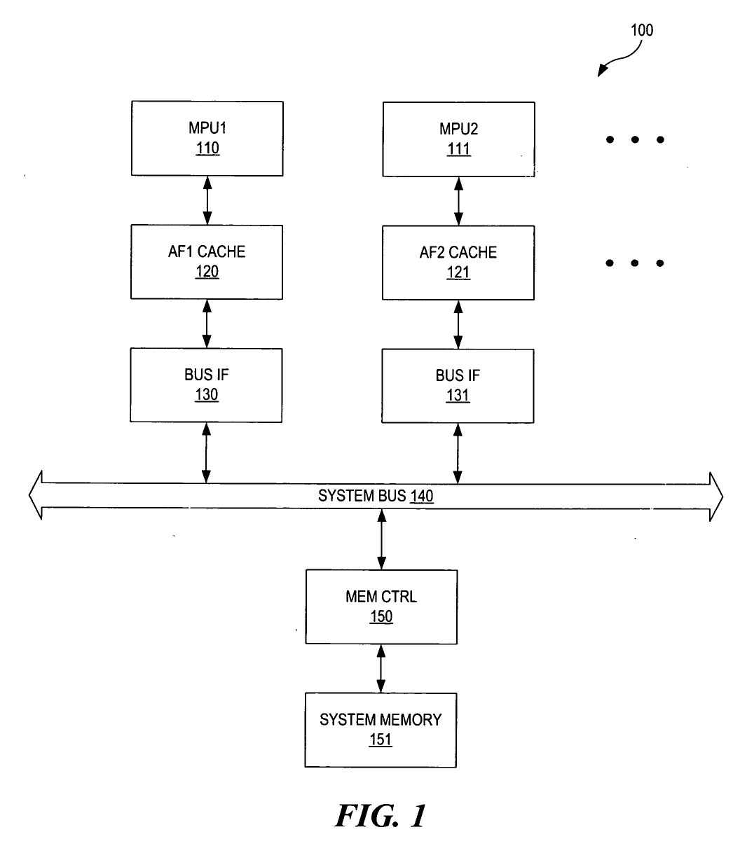

Turning to FIG. 1, disclosed is a multi-processor system 100 with a general central processor unit (MPU1) 110, (MPU2) 111 which can include an instruction unit, instruction cache, data cache, fixed point unit, floating point, local storage, and so on. Each processor is connected to a lower level cache called Atomic Facility (AF). Atomic Facility (AF1 Cache) 120, (AF2 Cache) 121 is connected to the Bus Interface unit (Bus IF) 130, (Bus IF) 131 and which in turn connects to the System Bus 140. Other processor's caches are connected to the system bus via bus interface units to have inter-processor communications. In addition to processors, a memory controller (Mem Ctr1) 150 is attached to the system bus 140 as well. A System Memory 151 is connected to the memory controller for common storage shared by multiple processors.

Generally, the system 100 provides a mechanism to disable write back operation on the reserved line from a Load and Reserve instruction of the lock acquisition software loop. The reserved line from the Load and reserve instruction is used in subsequent Store condition instruction in this lock acquisition loop. Hence, by keeping the reserved line in the cache, instead of writing back to memory and bring it back, is better in performance. By using various pointers, the victim line for write back is selected by LRU algorithm and the reservation line is not selected by skipping over this pointer.

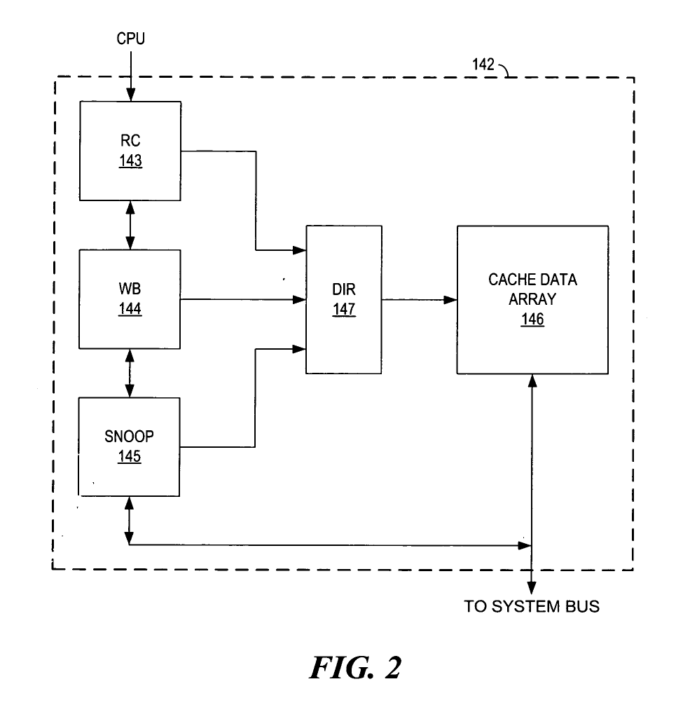

Turning now to FIG. 2, the view of an atomic facility 142 (hereafter referred to variably as “atomic facility” or “AF 142” is disclosed in more detail. Atomic facility includes data array circuitry 146 for data array and its control logic. Control logic includes a directory 147, RC (Read and Claim) finite state machine 143, to handle instructions from processor core, WB (write back) state machine to handle write back 144 and Snoop state machine 145. Directory 147 holds the cache tags and its states.

The RC machine 143 executes atomic instructions called, load and reserve, store conditional instructions for inter process synchronization. One purpose of this series of instructions is to synchronize operations between processors by giving ownership of common data to a processor in orderly fashion in multi-processor system.

A purpose, generally, of this series of instructions, is to synchronize operations between processors by giving ownership of the data to one processor at a time in multi-processor system. WB machine 144 handles write back for the RC machine when cache miss occur for load or store operations issued by MPU and when the atomic facility (AF) cache is full, and victim entry is modified state. Snoop machine 145 handles snoop operations coming from the system bus to maintain memory coherency throughout the system.

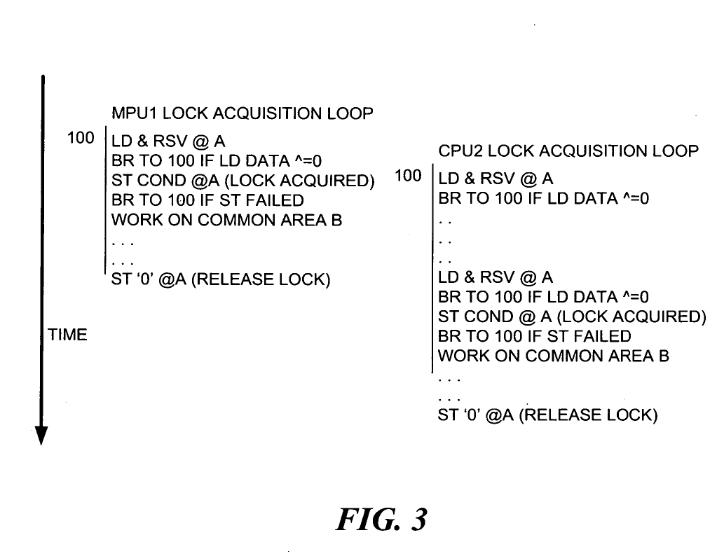

Turning now to FIG. 3, illustrated is an example of Lock acquisition scenario between 2 processors in a multi-processor system. Lock acquisition operation entails two main atomic instructions, a Load and Reserve atomic instruction, a Store conditional atomic instruction.

The Lock acquisition scenario as in MPU1 will first loop on Load and Reserve at “A” instruction until the released lock data pattern, zero's for simplicity, is loaded. During this instruction, a reservation flag is set with the reservation address in the RC machine. Once a lock is released by another processor, it can continue on to the next instruction called Store Conditional at “A”. This is a step to finalize the lock by storing its processor ID into the atomic line at address “A”. However this Store is conditional on reservation flag still being active. Another processor could have issued a store command to acquire same lock right before this Store conditional instruction.

Since cache coherency protocol is engaged on Atomic Facility cache, this store can be snooped by receiving a cache-line-kill or a read-exclusive snoop command on the same lock line address, which kills the current reservation.

Once the lock is achieved by successful Store conditional, a reservation flag is reset. If lock acquisition is unsuccessful, it restarts from load and reserve again. Therefore, the processor has a full ownership of the common storage area to do its work. During this time, other processors are lock out for any access to the common area. Once the work is completed, it releases the lock by storing ‘0’ to address “A.” At this time, a second processor, MPU2 can attain a lock when the second processor acquires the latest “A” data for the Load and Reserve instruction seeing the zero data pattern. The second processor continues with Store conditional instruction to finalize the lock as described above on the first processor.

Software has a tendency to reuse same lock line again, because in many cases lock acquisition is done in loop structure. So it is always good idea to preserve previous reservation line, because synchronization performance is critical for multi processor communication, and once lock line is invalidated from local cache, there is always serious performance degradation for atomic instructions.

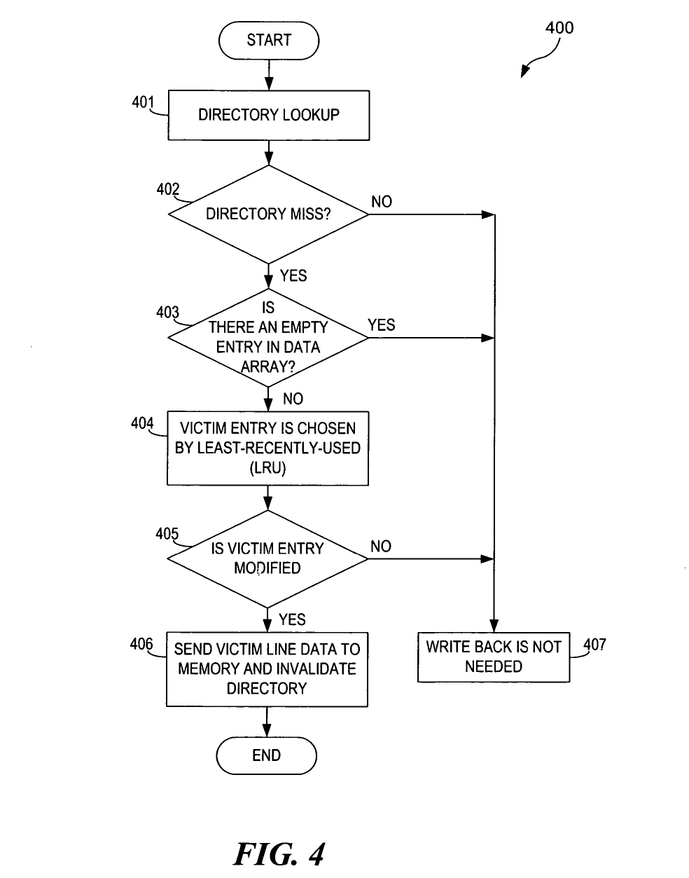

Turning now to FIG. 4, illustrated is one embodiment method 400 of write back operation. Generally, the method 400 describes a decision making process on the write back, as to whether write back is needed or not. Generally, this example implementation is such that the atomic facility (AF 142) has only one write back (WB) machine.

A write back request is dispatched by a ‘read and claim’ (RC) machine when load or store instructions and a directory lookup occur. In step 402, it is determined whether there is an executed RC miss on DIR (Directory) lookup and there is no room in the AF. If there is not, then in step 407 (will add), it is determined that a write back is not needed, and the method ends.

In step 403, the RC dispatches WB machine right after DIR lookup 301 and found a miss with no empty space (302 and 303) in Data Array. If there is an empty space in Data Array, then write back is not needed. If there is not an empty space, step 404 executes.

In step 404, the victim entry is chosen by the least recently used algorithm. If the designated least-recently-used victim entry 404 is modified, WB has to write the modified line 405 back to memory in order to make a room in AF.

In step 405, it is determined whether the victim entry is modified. If no, step 407 executes, and write back is deemed not to be needed. WB machine selects victim entry by using the Least Recently Used algorithm, modified and skips over the reservation entry. It continues with storing the victim entry to the memory to complete the write back operation 406.

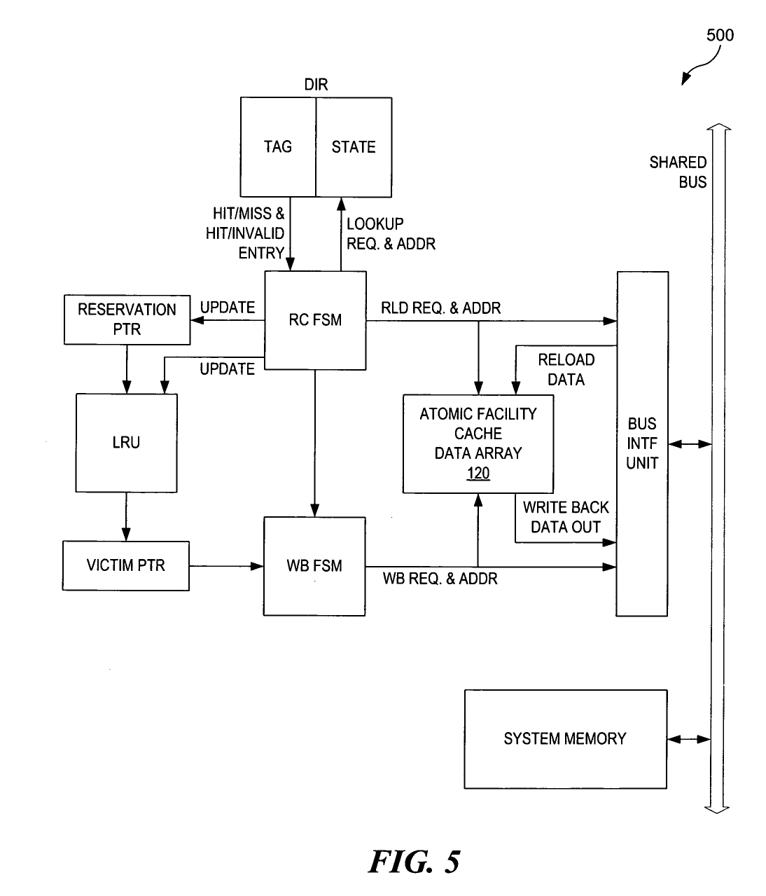

Turning now to FIG. 5, illustrated is a system 500 to manage the Atomic Facility 120, there is a pointer to point the cache line in Atomic Facility Data cache where Reservation exists. A victim pointer is used to write back a modified entry when there is a miss from an atomic instruction; the victim pointer denotes which information is to be written back out of the atomic cache, when the missed data is being reloaded. Since LRU algorithm never select Reservation pointer as victim pointer, the Load and Reserve data will never be written back to memory since it is used on subsequent Store conditional instruction. Therefore this capability will improve over all performance of an atomic operation in the Atomic Facility cache.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A method of managing an atomic facility cache write back controller, comprising:
establishing a reservation pointer pointing to the reserved line in the atomic facility data array;
making a write back selection; and
removing an entry for the reservation point for the write back selection whereby the reservation line is precluded form being selected for the write back.

2. The method of claim 1, wherein making a write back selection further comprises employing a victim entry selection function.

3. The method of claim 2, wherein the victim entry selection function comprises a least recently used algorithm.

4. A system for performing a write back to a cache, comprising:
an atomic facility cache having an atomic facility cache data array;
a reservation pointer configured to point to a reserved line in the atomic facility cache data array;
a victim entry selection mechanism configured to making a next write back selection, wherein the victim entry selection mechanism is further configured so that reservation line is precluded from being selected for the write back when valid write back entry is being selected.

5. A computer program product for managing an atomic facility cache write back controller, the computer program product having a medium with a computer program embodied thereon, the computer program comprising: computer code for establishing a reservation pointer pointing to the reserved line in the atomic facility data array;
computer code for making a write back selection; and
computer code for removing an entry for the reservation point for the write back selection whereby the valid reservation line is precluded form being selected for the write back.

6. A processor for managing an atomic facility cache write back controller, the processor including a computer program comprising:
computer code for establishing a reservation pointer pointing to the reserved line in the atomic facility data array;
computer code for making a write back selection; and
computer code for removing an entry for the reservation point for the write back selection whereby the valid reservation line is precluded form being selected for the write back.
